(19) United States
(12) Patent Application Publication
(10) Pub. No.: US 2009/0226859 A1
(43) Pub. Date: Sep. 10, 2009

(54) Educational games

(76) Inventors: Robert E. Alderson, JR., New York, NY (US); Sara Marie Alderson, New York, NY (US)

Correspondence Address: Robert E. Alderson, Jr., Apt. 4D, 241 West 108th Street, New York, NY, 10025, US

(21) Appl. No.: 12/378,926

(22) Filed: Feb. 19, 2009

Related U.S. Application Data
(60) Provisional application No. 61/066,231, filed on Feb. 19, 2008.

(51) Int. Cl. G09B 19/22

(52) U.S. Cl. 434/129

(57) ABSTRACT

Educational games designed to expose participants to areas of knowledge such as great works of literature and art are provided. Such educational games may be played either with or without a game board and are designed to be both effective and entertaining. Methods for playing such educational games are also provided.

### PRIORITY

This application claims priority to U.S. Provisional Application Ser. No. 61/066,231 filed on Feb. 19, 2008, the contents of which are hereby incorporated by reference.

### FIELD OF THE INVENTION

The present invention relates to educational games.

### BACKGROUND OF THE INVENTION

Recent surveys and studies have shown that the public in general and the American public in particular is deficient in its knowledge of literature and art. For example, a recent NEA study reported that while 54% of nine-year-olds read for pleasure, only about 21% of seventeen-year-olds do so. American families spend less-on books now as compared to almost any other time in the past two decades. A popular game show even pits fifth graders against adults, including some famously dimwitted celebrities, on the assumption that once people leave school, they retain little of what they are taught. That this phenomenon is interesting to the public is evidenced by the fact that a New York Times article entitled, “Dumb and Dumber: Are Americans Hostile to Knowledge?” remained near the top of the most e-mailed list for days after it appeared on Feb. 14, 2008, and garnered hundreds of reader comments.

Existing educational games and tools attempt to remedy some of these deficiencies. Such games and tools, however, are usually either ad hoc trivia-type games or rote memorization tools. These games and tools have not been very successful in remedying the knowledge deficiencies of the American public.

Accordingly, there exists a great need for educational games which expose participants to information such as great works of literature and art, but does so in a way that is both effective and entertaining.

### SUMMARY OF THE INVENTION

The present invention provides educational games designed to expose participants to areas of knowledge such as great works of literature and art. Such educational games may be played either with or without a game board and are designed to be both effective and entertaining.

One object of the present invention is to provide educational games comprising a plurality of game cards, wherein the game cards include one or more quotes from literature and one or more questions associated with the one or more quotes.

Another object of the present invention is to provide educational games comprising a game board, a plurality of tokens, and a plurality of game cards, wherein the game cards include one or more quotes from literature and one or more questions associated with the one or more quotes.

Another object of the present invention is to provide educational games comprising a plurality of game cards, wherein the game cards include one or more images of art and one or more questions associated with the one or more images.

Another object of the present invention is to provide educational games comprising a game board, a plurality of tokens, and a plurality of game cards wherein the game cards include one or more images of art and one or more questions associated with the one or more images.

Another object of the present invention is to provide methods of playing literary-based educational games among a plurality of players, wherein such games include a plurality of game cards, wherein the game cards include one or more quotes from literature and one or more questions associated with the one or more quotes.

Another object of the present invention is to provide methods of playing literary-based educational games among a plurality of players, wherein such games include a game board, a plurality of tokens, and a plurality of game cards, wherein the game cards include one or more quotes from literature and one or more questions associated with the one or more quotes.

Another object of the present invention is to provide methods of playing artistic-based educational games among a plurality of players, wherein such games include a plurality of game cards, wherein the game cards include one or more images of art and one or more questions associated with the one or more images.

Another object of the present invention is to provide methods of playing artistic-based educational games among a plurality of players, wherein such games include a game board, a plurality of tokens, and a plurality of game cards, wherein the game cards include one or more images of art and one or more questions associated with the one or more images.

### BRIEF DESCRIPTION OF THE DRAWINGS

FIG. 1 Illustrates an exemplary embodiment of a literary game card.

FIG. 2 Illustrates an exemplary embodiment of an educational game which includes a board, tokens and sets of literary game cards.

FIG. 3 Illustrates an exemplary embodiment of an artistic image game card.

### DETAILED DESCRIPTION OF THE INVENTION

The present invention is designed to improve participants' knowledge of various categories of information. Such information includes, but is not limited to, literature and art. Such educational games may be played either with or without a game board and are designed to be both effective and entertaining.

The present invention provides game cards which contain information and at least one question associated with the information. In certain embodiments, if a participant answers a question or questions correctly, the participant collects points or moves a token along a game board.

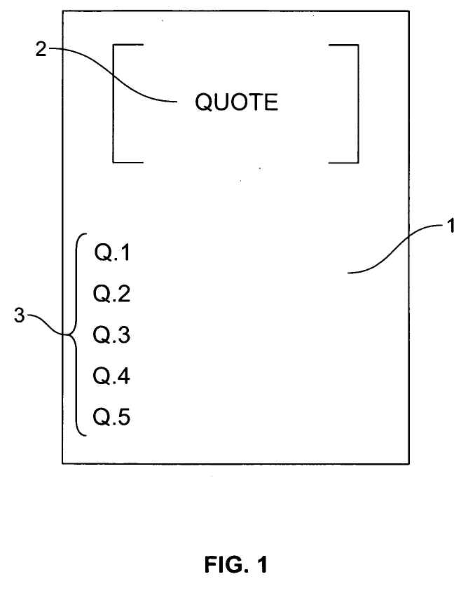

Referring now to FIG. 1, in a preferred embodiment, each game card (1) provides one or more quotes from literature (2) and includes at least one question (3) associated with the one or more quotes (2). For example, a game card (1) may include a quote (2) from the first line of Charles Dickens' Tale of Two Cities or any other literary work. The literary quote may be as short as a very short sentence or as long as several sentences or even a long paragraph. Preferably the quote will allow the participants to analyze the style sufficiently to make reasonable estimates about various aspects of the work as described below.

For example, one game participant may read the Dickens quote to another game participant and then ask, for example, a series of questions (3) about the quote. Such questions (3) may include, for example, whether the literary quote (2) is from a fiction or non-fiction work. This category could be expanded to include plays and poetry. Other categories of questions may include an estimate of the date in which the work was written, such as identifying the century in which the work was written or stating within a specified number of years (e.g., 50 or 100 years) the year in which the author wrote the work. Other categories of questions (3) may include identification of the country or original language in which the work was written, identification of the author, and identification of the specific work from which the quote was borrowed. Game cards (1) also preferably include answers to the questions (3). Answers may be provided immediately adjacent to each question, at the bottom of the game card (1) after the set of questions (3), upside-down along an edge of the game card (1) or in any convenient location, including a separate set of answer cards.

Each game card (1) may have the same categories of questions (3) as every other game card (e.g., fiction or non-fiction, century written etc.) or game cards (1) may have a variety of types of questions (2). Games also may include more than one set of game cards (1) such that game cards (1) in each set have roughly the same degree of difficulty and where different sets have different degrees of difficulty. For example, a game could include three sets of game cards (1), the first set having easier questions, the second set having moderately difficult questions, and the third set having the most difficult questions. In this way, people of different ages and knowledge can play in the same game, all of whom would then have a reasonable chance of winning.

The quotes (2) and questions (3) associated with the quotes (2) ideally will encourage participants to listen very carefully to the selected literary quotes (2). Over time, participants will improve their skills in identifying certain aspects of literary quotes (2), whether or not any given participant has ever heard a particular passage previously. The games also will arouse curiosity about literature and encourage participants to read the full work from which quotes were taken.

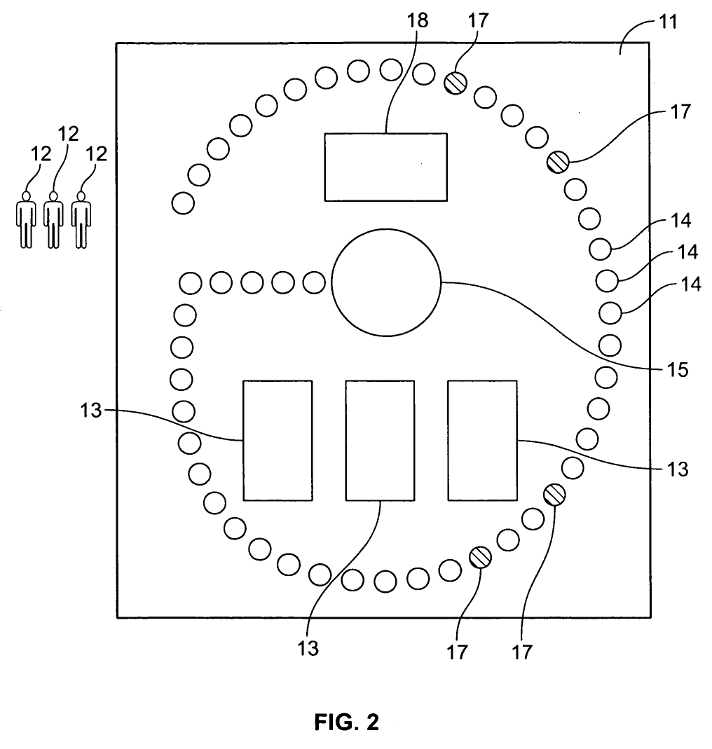

Referring now to FIG. 2, in certain embodiments games according to the present invention also may include a game board (11), a plurality of tokens (12), along with a plurality of games cards (13) such as those described above. The game board (11) may include a plurality of spaces (14) delineating the path and marking the progress from the beginning of the game to the end. The path on the game board may be configured in any number of conventional shapes or forms. For example, the path may be roughly circular, rectangular, spiral, triangular, or a combination of any of the above, or any other shape suitable for the game board. The path also may lead to a winner's area (15). The game board itself (11) may be made out of cardboard, wood or any other suitable material.

In certain embodiments, the plurality of spaces (14) on the board may include one or more special advancement spaces (17) which may direct a player to a separate set of advancement game cards (18). Such game cards may offer the player an opportunity to answer questions to move forward on the game board (11). Such questions may be similar to the regular game cards (13) or may include straightforward trivia-type questions (e.g., “Who wrote the book War and Peace?”)

Advancement game cards (18) also may include, for example, 2 or more questions, of varying difficulty. The player may choose which question he or she wants to try to answer. If the player picks the easiest question and answers it correctly, he or she may advance a certain number of spaces forward. If the player picks a more difficult question and answers it correctly, he or she may advance a greater number of spaces than a correct answer to the easier question would have allowed. Likewise, if a player chooses to try to answer the most difficult question (if 3 levels are used, for example) and succeeds in answering it correctly, that player may advance his or her token an even greater distance. For example, using a 3-level advancement card, answering the easiest, intermediate or most difficult question correctly might allow the player to advance, respectively, 1, 2 or 3 spaces. In certain embodiments of the game, the player chooses the level of difficulty of the question on the advancement card prior to hearing the question.

In certain embodiments, tokens (12) may be used by the participants to help keep track of their progress. Tokens (12) may be made from any suitable material such as plastic, metal, or cardboard. In certain literary embodiments, the literary tokens (12) may suggest an image or caricature of a historic author. For example, literary tokens (12) might represent Mark Twain, Walt Whitman or Horner. Likewise, in certain artistic embodiments, the artistic tokens (12) may suggest an image or caricature of a historic artist. For example, artistic tokens (12) might represent Picasso, Da Vinci or Michelangelo.

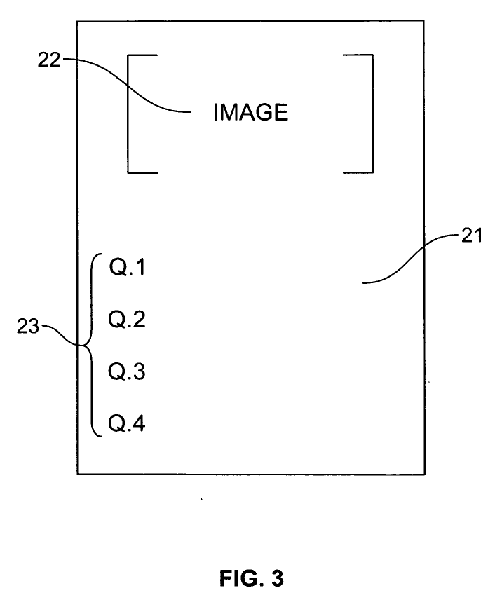

Referring now to FIG. 3, in alternate embodiments of the present invention, rather than including literary quotes (2) on the game cards (1), artistic images (22) may be shown on artistic-based game cards (21) instead. One or more questions (23) associated with the artistic image (22) may be included on the game card (21). In artistic embodiments the questions (23) and answers may be designed in such a manner that the participant who is trying to identify various aspects of the image (22) cannot see the questions (23) and answers associated with the image. In certain embodiments this may be achieved, for example, by providing game cards (21) with artistic images (22) on one side of the game cards and questions (23) and answers on the other side of the game cards (21). This also may be achieved, for example, by having one set of game cards (21) for the image (22) and another set of game cards (21) for the questions (23) and answers. Alternatively, game cards (21) used in artistic embodiments may use a flap or pocket that keeps the questions (23) and answers hidden from the player tasked with identifying the image (22).

As with embodiments of the invention involving literary quotes, artistic image embodiments of the present invention may be used with a game board and tokens. Advancement cards, as described above, also may be used.

Subject matter other than art or literature may be used as well. For example, geography, science, music and other categories of knowledge may be incorporated into the present invention. Preferably, each game uses game cards relating to a singe topic (e.g., literature, art etc.), but in some embodiments various combinations of topics may be used. As with literature, a major goal of the present invention is to expose participants to interesting areas of knowledge. Such exposure should encourage further exploration into those areas.

The present invention also includes literary and/or artistic educational games and methods of playing such games, wherein such games are accessed through and/or played on the internet, intranet, world wide web, software applications (including CDs and DVDs), telephone, cable, video, magnetic, electronic, or other communication means. These embodiments also can include games and methods of playing such games wherein music, particularly classical music, is substituted for literary and/or artistic subject matter.

### EXAMPLES

### Example 1

This Example provides a description of how of a representative literary embodiment of the present invention may be played. In this embodiment, 3 players of different skill levels play on a game board such as that shown in FIG. 2. In this Example, the players include a 12-year-old 7th grader, a 40-year-old portrait artist and a 45-year-old patent attorney. The 7th grader plays with the easiest level set of cards; the portrait artist plays with the most difficult level set of cards; and the patent attorney plays with the intermediate level set of cards.

The portrait artist reads a card to the 7th grader. The quote is: “Macbeth doth murder sleep.” The 7th grader correctly answers that (1) the quote is from a play (2) the quote was written within 50 years of 1600 (3) the quote was written in England (4) the quote was written by William Shakespeare and (5) the quote is from Shakespeare's Macbeth. The 7th grader advances her token 5 spaces.

The 7th grader reads a quote to the patent attorney. The quote is from Thoreau's Walden. The patent attorney correctly answers that (1) the quote is from a non-fiction work (2) the quote was written in the United States and (3) the quote was written in the 19th century. The patent attorney is not able to identify Thoreau as the author or Walden as the name of the work. The patent attorney advances his token 3 spaces. (In the future the patent attorney will be better able to identify Thoreau.)

The patent attorney reads a quote to the portrait artist. The quote is a not easily identifiable translated paragraph from Tolstoy's War and Peace. The portrait artist correctly identifies that the quote (1) is from a fiction work (2) was written in the 19th century (3) was written in Russia (4) was written by Tolstoy and (5) is from War and Peace. The portrait artist advances her token 5 spaces.

Play continues in this fashion until one of the players answers enough questions correctly to advance his or her token to the end of the path to win the game. During the course of the game, one or more players may land on one or more of the special advancement spaces. In this Example, the 7th grader lands on a special advancement space and chooses to try to answer the easiest question on the card for an opportunity to advance one space. In this embodiment of the game, the player chooses the level of difficulty of the question prior to hearing the question. The 7th grader correctly identifies the author of 1984 as George Orwell and advances her token 1 space. The patent attorney also lands on an advancement space and chooses to try to answer the most difficult question to catch up to his competitors. Unfortunately, he is unable to identify Dava Sobel as the author of Longitude and cannot advance further on this turn. The portrait artist does not land on an advancement space. Nevertheless, she wins the game by a couple of spaces over the 7th grader and by many spaces over the patent attorney.

Prophetic Examples 2-7 below illustrate some of the benefits achieved by certain literary and artistic embodiments of the present invention.

Prophetic Examples 2-4 below illustrate some of the benefits achieved by a literary embodiment of the present invention. The embodiment used in Examples 1-3 uses a game board, tokens and three sets of games cards, each set having different levels of difficulty.

Prophetic Examples 4-7 below illustrate some of the benefits achieved by an artistic embodiment of the present invention. The embodiment used in Examples 4-6 uses a game board, tokens and three sets of games cards, each set having different levels of difficulty.

### Example 2

A 12-year-old girl in 7th grade obtains and regularly plays an literary embodiment of the present invention which she plays with her older siblings and her parents. She mainly uses the easiest set of game cards. After several weeks this subject displays a markedly increased ability to recognize various styles of writing, develops a lifelong interest in literature, spends more time with her family, and watches much less television.

### Example 3

A 20-year-old college student majoring in chemistry plans to apply to medical school. She obtains and then regularly plays a literary embodiment of the present invention with her roommates and friends. She mainly uses an intermediate level set of game cards. After several weeks this subject displays a markedly increased ability to recognize various styles of writing, enrolls in literature classes which are not required for her major, develops a lifelong interest in literature which provides her with a good balance to her medical school studies, and she watches much less television.

### Example 4

A 45-year-old patent attorney works 50 hours per week, watches television 20 hours per week and reads 4 books per year. He obtains and then regularly plays a literary embodiment of the present invention with his wife and children. He mainly uses an intermediate level set of game cards. After several weeks he uses a more advanced set of game cards more often. He displays a markedly increased ability to recognize various styles of writing, gradually develops what will become a lifelong interest in literature, reads 20 or more books per year, spends more time with his family, and watches much less television.

A 12-year-old girl in 7th grade obtains and regularly plays an artistic embodiment of the present invention which she plays with her older siblings and her parents. She mainly uses the easiest set of game cards. After several weeks this subject displays a markedly increased ability to recognize various styles of art, develops a lifelong interest in art, spends more time with her family, spends more time in art museums, and watches much less television.

### Example 6

A 20-year-old college student majoring in chemistry plans to apply to medical school. She obtains and then regularly plays an artistic embodiment of the present invention with her roommates and friends. She mainly uses an intermediate level set of game cards. After several weeks this subject displays a markedly increased ability to recognize various styles of art, enrolls in art history classes which are not required for her major, develops a lifelong interest in art which provides a good balance to her medical school studies, she regularly visits local art museums, and she watches much less television.

### Example 7

A 45-year-old patent attorney works 50 hours per week, watches television 20 hours per week and reads 4 books per year. He obtains and then regularly plays an artistic embodiment of the present invention with his wife and children. He mainly uses an intermediate level set of game cards. After several weeks he uses a more advanced set of game cards more often. He displays a markedly increased ability to recognize various styles of art, gradually develops what will become a lifelong interest in art, visits local art museums, when travelling visits art museums in the area, reads 20 or more books per year, spends more time with his family, and watches much less television.

What is claimed is:

1. An educational game comprising a plurality of game cards, said game cards comprising at least one quote from literature and at least one question associated with the at least one quote.

2. The educational game of claim 1, further comprising a game board.

3. The educational game of claim 1, further comprising a game board and tokens.

4. The educational game of claim 3, wherein the game board comprises predefined spaces, said spaces defining a path from a starting point to an ending point.

5. The educational game of claim 3, wherein the plurality of game cards are arranged in a plurality of sets, wherein game cards within a given set among the plurality of sets include questions having a relatively uniform level of difficulty.

6. A method of playing a literary-based educational game among a plurality of players, said method comprising providing a plurality of game cards, wherein said game cards include a least one quote from literature and at least one question associated with the at least one quote.

7. The method of claim 6, wherein the at least one question is selected from the group consisting of: the type of literary work, the approximate date on which the literary work was written, the country in which the literary work was written, the author of the literary work, and the name of the literary work, the at least one question appearing alone or in any combination.

8. The method of claim 7, wherein an answer to the type of literary work is selected from at least two of the group consisting of: fiction, non-fiction, a play, and poetry.

9. The method of claim 7, wherein an answer to the date in which the literary work is written is either the century in which the work was written or a fixed number of years before or after which the work was written.

10. The method of claim 8, wherein the fixed number of years before or after which the work was written is no greater than 100 years.

11. The method of claim 6, further comprising the step of providing tokens and a game board whereby the players move said tokens toward a winner's circle goal in order to be declared a winner.

12. An educational game comprising a plurality of game cards, said game cards comprising at least one artistic image and at least one question associated with the at least one quote.

13. The educational game of claim 12, further comprising a game board.

14. The educational game of claim 12, further comprising a game board and tokens.

15. The educational game of claim 14, wherein the game board comprises predefined spaces, said spaces defining a path from a starting point to an ending point.

16. The educational game of claim 14, wherein the plurality of game cards are arranged in a plurality of sets, wherein game cards within a given set among the plurality of sets include questions having a relatively uniform level of difficulty.

17. A method of playing an artistic-based educational game among a plurality of players, said method comprising providing a plurality of game cards, wherein said game cards include a least one artistic image and at least one question associated with the at least one artistic image.

18. The method of claim 17, wherein the at least one question is selected from the group consisting of: the approximate date on which the artistic image was created, the country in which the literary work was created, the name of the artist who created the artistic image, and the name of the artistic image, the at least one question appearing alone or in any combination.

19. The method of claim 18, wherein an answer to the date in which the artistic image was created is either the century in which the artistic image was created or a fixed number of years before or after which the artistic image was created.

20. The method of claim 20, wherein the fixed number of years before or after which the artistic image was created is no greater than 100 years.

21. The method of claim 21, further comprising the step of providing tokens and a game board whereby the players move said tokens toward a winner's circle goal in order to be declared a winner.
